(19) United States
(12) Patent Application Publication
(10) Pub. No.: US 2019/0320172 A1
(43) Pub. Date: Oct. 17, 2019

(54) HARDWARE-FRIENDLY SAMPLE ADAPTIVE OFFSET (SAO) AND ADAPTIVE LOOP FILTER (ALF) FOR VIDEO CODING

(71) Applicant: QUALCOMM Incorporated, San Diego, CA (US)

(72) Inventors: Li Zhang, San Diego, CA (US); Cheng-Teh Hsieh, Del Mar, CA (US); Kai Zhang, San Diego, CA (US); Akshay Gadde, Fremont, CA (US); Wei-Jung Chien, San Diego, CA (US); Marta Karczewicz, San Diego, CA (US)

(21) Appl. No.: 16/381,958

(22) Filed: Apr. 11, 2019

Related U.S. Application Data
(60) Provisional application No. 62/656,919, filed on Apr. 12, 2018.

(51) Int. Cl. H04N 19/117; H04N 19/189; H04N 19/70; H04N 19/169

(52) U.S. Cl. CPC H04N 19/117; H04N 19/1883; H04N 19/70; H04N 19/189

(57) ABSTRACT

A video decoder configured to determine filter information for a region of a picture of video data; for a largest coding unit (LCU) of the region, determine a size for a current unit based on a location of the LCU within the picture, wherein the size for the current unit is different than a size of the LCU; and based on the determined filter information, determine a filter for the current unit of the region; and filter the current unit with the determined filter.

This application claims the benefit of U.S. Provisional Patent Application 62/656,919, filed Apr. 12, 2018, the entire content of which is hereby incorporated by reference.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the recently finalized High Efficiency Video Coding (HEVC) standard, and extensions of such standards. The video devices may transmit, receive, encode, decode, and/or store digital video information more efficiently by implementing such video compression techniques.

Video compression techniques perform spatial (intra-picture) prediction and/or temporal (inter-picture) prediction to reduce or remove redundancy inherent in video sequences. For block-based video coding, a video slice (i.e., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

This disclosure describes techniques related to filtering operations which could be used in a post-processing stage, as part of in-loop coding, or in the prediction stage. The techniques of this disclosure may be implemented into existing video codecs, such as HEVC (High Efficiency Video Coding), or be an efficient coding tool for a future video coding standard, such as the H.266 standard presently under development.

In one example, a method of decoding video data includes determining filter information for a region of a picture of video data; for a largest coding unit (LCU) of the region, determining a size for a current unit based on a location of the LCU within the picture, wherein the size for the current unit is different than a size of the LCU; based on the determined filter information, determining a filter for the current unit of the region; and filtering the current unit with the determined filter.

According to another example, a device for decoding video data includes a memory configured to store video data and one or more processors configured to determine filter information for a region of a picture of the video data; for a largest coding unit (LCU) of the region, determine a size for a current unit based on a location of the LCU within the picture, wherein the size for the current unit is different than a size of the LCU; based on the determined filter information, determine a filter for the current unit of the region; and filter the current unit with the determined filter.

According to another example, an apparatus for coding video data includes means for determining filter information for a region of a picture of video data; means for determining a size for a current unit based on a location of a largest coding unit (LCU) of the region within the picture, wherein the size for the current unit is different than a size of the LCU; means for determining a filter for the current unit of the region based on the determined filter information; and means for filtering the current unit with the determined filter.

According to another example, a computer readable storage medium stores instructions that when executed cause one or more processors to determine filter information for a region of a picture of the video data; for a largest coding unit (LCU) of the region, determine a size for a current unit based on a location of the LCU within the picture, wherein the size for the current unit is different than a size of the LCU; based on the determined filter information, determine a filter for the current unit of the region; and filter the current unit with the determined filter.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may utilize the techniques described in this disclosure.

FIG. 2 is a conceptual diagram illustrating deblock filtering across a vertical block boundary.

FIGS. 3A-3D show four 1-D directional patterns for edge offset (EO) sample classification.

FIG. 4 is a conceptual diagram illustrating largest coding units and deblock-processed units.

FIG. 5 is a conceptual diagram illustrating a slice with multiple regions. Each region of the slice illustrated in FIG. 5 contains one or more largest coding units.

FIG. 6 is a block diagram illustrating an example video encoder that may implement the techniques described in this disclosure.

FIG. 7 is a block diagram illustrating an example video decoder that may implement the techniques described in this disclosure.

FIG. 8 shows an example implementation of a filter unit for performing the techniques of this disclosure.

FIG. 9 is a flowchart illustrating an example method of decoding video data in accordance with techniques described in this disclosure.

### DETAILED DESCRIPTION

This disclosure describes techniques related to filtering operations which could be used in a post-processing stage, as part of in-loop coding, or in the prediction stage. The techniques of this disclosure may be implemented into existing video codecs, such as HEVC (High Efficiency Video Coding), or be an efficient coding tool for a future video coding standard, such as the H.266 standard presently under development.

Video coding typically involves predicting a block of video data from either an already coded block of video data in the same picture (i.e. intra prediction) or an already coded block of video data in a different picture (i.e. inter prediction). In some instances, the video encoder also calculates residual data by comparing the predictive block to the original block. Thus, the residual data represents a difference between the predictive block and the original block. The video encoder transforms and quantizes the residual data and signals the transformed and quantized residual data in the encoded bitstream. A video decoder adds the residual data to the predictive block to produce a reconstructed video block that matches the original video block more closely than the predictive block alone. To further improve the quality of decoded video, a video decoder can perform one or more filtering operations on the reconstructed video blocks. Examples of these filtering operations include deblocking filtering, sample adaptive offset (SAO) filtering, and adaptive loop filtering (ALF). Parameters for these filtering operations may either be determined by a video encoder and explicitly signaled in the encoded video bitstream or may be implicitly determined by a video decoder without needing the parameters to be explicitly signaled in the encoded video bitstream.

This disclosure describes techniques related to filtering methods referred to as “Sample Adaptive Offset (SAO)” and “Adaptive Loop Filter (ALF).” SAO and/or ALF may be used in a post-processing stage or for in-loop coding or in the prediction stage. SAO and/or ALF may be applied to any of various existing video codec technologies, such as codecs High Efficiency Video Coding (HEVC) compliant codec technology or be an efficient coding tool in any future video coding standards. HEVC and JEM techniques related to this disclosure are discussed below.

As used in this disclosure, the term video coding generically refers to either video encoding or video decoding. Similarly, the term video coder may generically refer to a video encoder or a video decoder. Moreover, certain techniques described in this disclosure with respect to video decoding may also apply to video encoding, and vice versa. For example, often times video encoders and video decoders are configured to perform the same process, or reciprocal processes. Also, video encoder typically perform video decoding as part of the processes of determining how to encode video data.

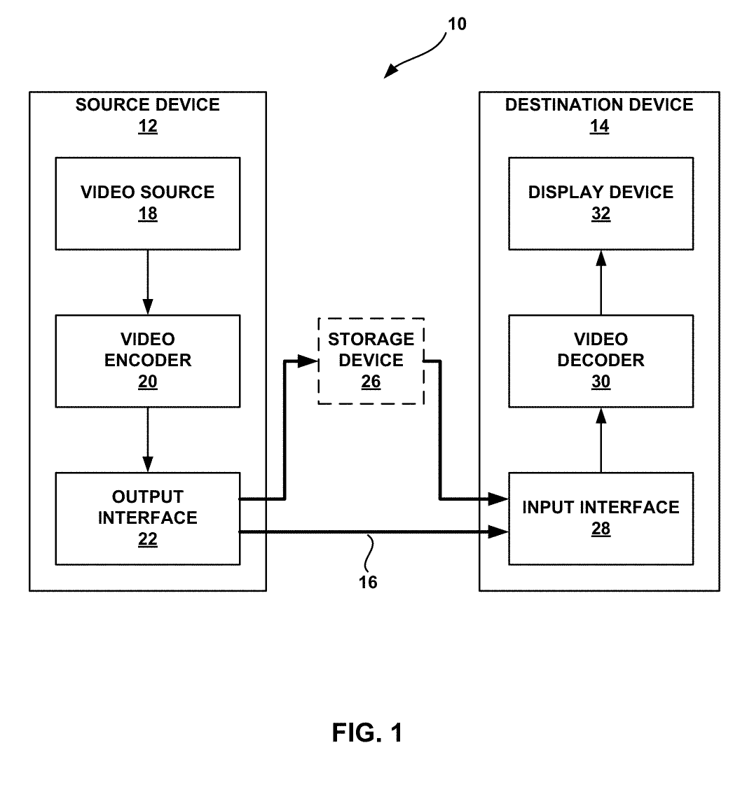

FIG. 1 is a block diagram illustrating an example video encoding and decoding system 10 that may utilize the techniques described in this disclosure. As shown in FIG. 1, system 10 includes a source device 12 that generates encoded video data to be decoded at a later time by a destination device 14. Source device 12 and destination device 14 may be any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via a link 16. Link 16 may be any type of medium or device capable of moving the encoded video data from source device 12 to destination device 14. In one example, link 16 may be a communication medium to enable source device 12 to transmit encoded video data directly to destination device 14 in real-time. The encoded video data may be modulated according to a communication standard, such as a wireless communication protocol, and transmitted to destination device 14. The communication medium may include any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

In another example, encoded data may be output from output interface 22 to a storage device 26. Similarly, encoded data may be accessed from storage device 26 by input interface. Storage device 26 may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, storage device 26 may correspond to a file server or another intermediate storage device that may hold the encoded video generated by source device 12. Destination device 14 may access stored video data from storage device 26 via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from storage device 26 may be a streaming transmission, a download transmission, or a combination of both.

The techniques of this disclosure are not necessarily limited to wireless applications or settings. The techniques may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes a video source 18, video encoder 20 and an output interface 22. In some cases, output interface 22 may include a modulator/demodulator (modem) and/or a transmitter. In source device 12, video source 18 may include a source such as a video capture device, e.g., a video camera, a video archive containing previously captured video, a video feed interface to receive video from a video content provider, and/or a computer graphics system for generating computer graphics data as the source video, or a combination of such sources. As one example, if video source 18 is a video camera, source device 12 and destination device 14 may form so-called camera phones or video phones. However, the techniques described in this disclosure may be applicable to video coding in general, and may be applied to wireless and/or wired applications.

The captured, pre-captured, or computer-generated video may be encoded by video encoder 20. The encoded video data may be transmitted directly to destination device 14 via output interface 22 of source device 12. The encoded video data may also (or alternatively) be stored onto storage device 26 for later access by destination device 14 or other devices, for decoding and/or playback.

Destination device 14 includes an input interface 28, a video decoder 30, and a display device 32. In some cases, input interface 28 may include a receiver and/or a modem. Input interface 28 of destination device 14 receives the encoded video data over link 16. The encoded video data communicated over link 16, or provided on storage device 26, may include a variety of syntax elements generated by video encoder 20 for use by a video decoder, such as video decoder 30, in decoding the video data. Such syntax elements may be included with the encoded video data transmitted on a communication medium, stored on a storage medium, or stored a file server.

Display device 32 may be integrated with, or external to, destination device 14. In some examples, destination device 14 may include an integrated display device and also be configured to interface with an external display device. In other examples, destination device 14 may be a display device. In general, display device 32 displays the decoded video data to a user, and may be any of a variety of display devices such as a liquid crystal display (LCD), a plasma display, an organic light emitting diode (OLED) display, or another type of display device.

Video encoder 20 and video decoder 30 may operate according to a video compression standard, such as the recently finalized High Efficiency Video Coding (HEVC) standard and may conform to the HEVC Test Model (HM). Video encoder 20 and video decoder 30 may additionally operate according to an HEVC extension, such as the range extension, the multiview extension (MV-HEVC), or the scalable extension (SHVC) which have been developed by the Joint Collaboration Team on Video Coding (JCT-VC) as well as Joint Collaboration Team on 3D Video Coding Extension Development (JCT-3V) of ITU-T Video Coding Experts Group (VCEG) and ISO/IEC Motion Picture Experts Group (MPEG). Alternatively, video encoder 20 and video decoder 30 may operate according to other proprietary or industry standards, such as the ITU-T H.264 standard, alternatively referred to as ISO/IEC MPEG-4, Part 10, Advanced Video Coding (AVC), or extensions of such standards, such as the Scalable Video Coding (SVC) and Multi-view Video Coding (MVC) extensions. The techniques of this disclosure, however, are not limited to any particular coding standard. Other examples of video compression standards include ITU-T H.261, ISO/IEC MPEG-1 Visual, ITU-T H.262 or ISO/IEC MPEG-2 Visual, ITU-T H.263, and ISO/IEC MPEG-4 Visual. HEVC (ITU-T H.265), including its range extension, multiview extension (MV-HEVC) and scalable extension (SHVC), were developed by the Joint Collaboration Team on Video Coding (JCT-VC) as well as the Joint Collaboration Team on 3D Video Coding Extension Development (JCT-3V) of ITU-T Video Coding Experts Group (VCEG) and ISO/IEC Motion Picture Experts Group (MPEG). The finalized HEVC draft, referred to as HEVC WD hereinafter, is available at http://phenix.int-evry.fr/jct/doc_end_user/documents/14_Vienna/wg11/JCTVC-N1003-v1.zip.

Video encoder 20 and video decoder 30 may also operate according to other proprietary or industry standards, such as the ITU-T H.264 standard, alternatively referred to as ISO/IEC MPEG-4, Part 10, Advanced Video Coding (AVC), or extensions of such standards, such as the Scalable Video Coding (SVC) and Multi-view Video Coding (MVC) extensions. The techniques of this disclosure, however, are not limited to any particular coding standard. Other examples of video compression standards include ITU-T H.261, ISO/IEC MPEG-1 Visual, ITU-T H.262 or ISO/IEC MPEG-2 Visual, ITU-T H.263, and ISO/IEC MPEG-4 Visual.

ITU-T VCEG (Q6/16) and ISO/IEC MPEG (JTC 1/SC 29/WG 11) are now studying the potential need for standardization of future video coding technology with a compression capability that potentially exceeds that of the current HEVC standard (including its current extensions and near-term extensions for screen content coding and high-dynamic-range coding). The groups are working together on this exploration activity in a joint collaboration effort known as the Joint Video Exploration Team (JVET) to evaluate compression technology designs proposed by their experts in this area. The JVET first met during 19-21 Oct. 2015. the latest version of the reference software, i.e., Joint Exploration Model 7 (JEM 7) can be downloaded from: https://jvet.hhi.fraunhofer.de/svn/svn_HMJEMSoftware/tags/HM-16.6-JEM-7.0/ The algorithm description for JEM7 is described in J. Chen, E. Alshina, G. J. Sullivan, J.-R. Ohm, J. Boyce “Algorithm description of Joint Exploration Test Model 7 (JEM7),” JVET-G1001, Torino, July 2017.

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

Video encoder 20 and video decoder 30 each may be implemented as any of a variety of suitable encoder circuitry or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

In HEVC and other video coding specifications, a video sequence typically includes a series of pictures. Pictures may also be referred to as “frames.” In one example approach, a picture may include three sample arrays, denoted S_{L}, S_{Cb}, and S_{Cr}. In such an example approach, S_{L} is a two-dimensional array (i.e., a block) of luma samples. S_{Cb} is a two-dimensional array of Cb chrominance samples. S_{Cr} is a two-dimensional array of Cr chrominance samples. Chrominance samples may also be referred to herein as “chroma” samples. In other instances, a picture may be monochrome and may only include an array of luma samples.

To generate an encoded representation of a picture, video encoder 20 may generate a set of coding tree units (CTUs). Each of the CTUs may include a coding tree block of luma samples, two corresponding coding tree blocks of chroma samples, and syntax structures used to code the samples of the coding tree blocks. In monochrome pictures or pictures having three separate color planes, a CTU may include a single coding tree block and syntax structures used to code the samples of the coding tree block. A coding tree block may be an N×N block of samples. A CTU may also be referred to as a “tree block” or a “largest coding unit” (LCU). The CTUs of HEVC may be broadly analogous to the macroblocks of other standards, such as H.264/AVC. However, a CTU is not necessarily limited to a particular size and may include one or more coding units (CUs). A slice may include an integer number of CTUs ordered consecutively in a raster scan order.

To generate a coded CTU, video encoder 20 may recursively perform quad-tree partitioning on the coding tree blocks of a CTU to divide the coding tree blocks into coding blocks, hence the name “coding tree units.” A coding block may be an N×N block of samples. A CU may include a coding block of luma samples and two corresponding coding blocks of chroma samples of a picture that has a luma sample array, a Cb sample array, and a Cr sample array, and syntax structures used to code the samples of the coding blocks. In monochrome pictures or pictures having three separate color planes, a CU may include a single coding block and syntax structures used to code the samples of the coding block.

Video encoder 20 may partition a coding block of a CU into one or more prediction blocks. A prediction block is a rectangular (i.e., square or non-square) block of samples on which the same prediction is applied. A prediction unit (PU) of a CU may include a prediction block of luma samples, two corresponding prediction blocks of chroma samples, and syntax structures used to predict the prediction blocks. In monochrome pictures or pictures having three separate color planes, a PU may include a single prediction block and syntax structures used to predict the prediction block. Video encoder 20 may generate predictive luma, Cb, and Cr blocks for luma, Cb, and Cr prediction blocks of each PU of the CU.

Video encoder 20 may use intra prediction or inter prediction to generate the predictive blocks for a PU. If video encoder 20 uses intra prediction to generate the predictive blocks of a PU, video encoder 20 may generate the predictive blocks of the PU based on decoded samples of the picture associated with the PU. If video encoder 20 uses inter prediction to generate the predictive blocks of a PU, video encoder 20 may generate the predictive blocks of the PU based on decoded samples of one or more pictures other than the picture associated with the PU.

After video encoder 20 generates predictive luma, Cb, and Cr blocks for one or more PUs of a CU, video encoder 20 may generate a luma residual block for the CU. Each sample in the CU's luma residual block indicates a difference between a luma sample in one of the CU's predictive luma blocks and a corresponding sample in the CU's original luma coding block. In addition, video encoder 20 may generate a Cb residual block for the CU. Each sample in the CU's Cb residual block may indicate a difference between a Cb sample in one of the CU's predictive Cb blocks and a corresponding sample in the CU's original Cb coding block. Video encoder 20 may also generate a Cr residual block for the CU. Each sample in the CU's Cr residual block may indicate a difference between a Cr sample in one of the CU's predictive Cr blocks and a corresponding sample in the CU's original Cr coding block.

Furthermore, video encoder 20 may use quad-tree partitioning to decompose the luma, Cb, and Cr residual blocks of a CU into one or more luma, Cb, and Cr transform blocks. A transform block is a rectangular (e.g., square or non-square) block of samples on which the same transform is applied. A transform unit (TU) of a CU may include a transform block of luma samples, two corresponding transform blocks of chroma samples, and syntax structures used to transform the transform block samples. Thus, each TU of a CU may be associated with a luma transform block, a Cb transform block, and a Cr transform block. The luma transform block associated with the TU may be a sub-block of the CU's luma residual block. The Cb transform block may be a sub-block of the CU's Cb residual block. The Cr transform block may be a sub-block of the CU's Cr residual block. In monochrome pictures or pictures having three separate color planes, a TU may include a single transform block and syntax structures used to transform the samples of the transform block.

Video encoder 20 may apply one or more transforms to a luma transform block of a TU to generate a luma coefficient block for the TU. A coefficient block may be a two-dimensional array of transform coefficients. A transform coefficient may be a scalar quantity. Video encoder 20 may apply one or more transforms to a Cb transform block of a TU to generate a Cb coefficient block for the TU. Video encoder 20 may apply one or more transforms to a Cr transform block of a TU to generate a Cr coefficient block for the TU.

The above block structure with CTUs, CUs, PUs, and TUs generally describes the block structure used in HEVC. Other video coding standards, however, may use different block structures. As one example, although HEVC allows PUs and TUs to have different sizes or shapes, other video coding standards may require predictive blocks and transform blocks to have a same size. The techniques of this disclosure are not limited to the block structure of HEVC and may be compatible with other block structures.

After generating a coefficient block (e.g., a luma coefficient block, a Cb coefficient block or a Cr coefficient block), video encoder 20 may quantize the coefficient block. Quantization generally refers to a process in which transform coefficients are quantized to possibly reduce the amount of data used to represent the transform coefficients, providing further compression. After video encoder 20 quantizes a coefficient block, video encoder 20 may entropy encode syntax elements indicating the quantized transform coefficients. For example, video encoder 20 may perform Context-Adaptive Binary Arithmetic Coding (CABAC) on the syntax elements indicating the quantized transform coefficients.

Video encoder 20 may output a bitstream that includes a sequence of bits that forms a representation of coded pictures and associated data. The bitstream may include a sequence of Network Abstraction Layer (NAL) units. A NAL unit is a syntax structure containing an indication of the type of data in the NAL unit and bytes containing that data in the form of a raw byte sequence payload (RBSP) interspersed as necessary with emulation prevention bits. Each of the NAL units includes a NAL unit header and encapsulates a RBSP. The NAL unit header may include a syntax element that indicates a NAL unit type code. The NAL unit type code specified by the NAL unit header of a NAL unit indicates the type of the NAL unit. A RBSP may be a syntax structure containing an integer number of bytes that is encapsulated within a NAL unit. In some instances, an RBSP includes zero bits.

Different types of NAL units may encapsulate different types of RBSPs. For example, a first type of NAL unit may encapsulate an RBSP for a PPS, a second type of NAL unit may encapsulate an RBSP for a coded slice, a third type of NAL unit may encapsulate an RBSP for SEI messages, and so on. NAL units that encapsulate RBSPs for video coding data (as opposed to RBSPs for parameter sets and SEI messages) may be referred to as VCL NAL units.

Video decoder 30 may receive a bitstream generated by video encoder 20. In addition, video decoder 30 may parse the bitstream to obtain syntax elements from the bitstream. Video decoder 30 may reconstruct the pictures of the video data based at least in part on the syntax elements obtained from the bitstream. The process to reconstruct the video data may be generally reciprocal to the process performed by video encoder 20. In addition, video decoder 30 may inverse quantize coefficient blocks associated with TUs of a current CU. Video decoder 30 may perform inverse transforms on the coefficient blocks to reconstruct transform blocks associated with the TUs of the current CU. Video decoder 30 may reconstruct the coding blocks of the current CU by adding the samples of the predictive blocks for PUs of the current CU to corresponding samples of the transform blocks of the TUs of the current CU. By reconstructing the coding blocks for each CU of a picture, video decoder 30 may reconstruct the picture.

Aspects of HEVC and JEM techniques will now be discussed. HEVC employs two in-loop filters including de-blocking filter (DBF) and SAO. Additional details regarding HEVC decoding and SAO are described in C. Fu, E. Alshina, A. Alshin, Y. Huang, C. Chen, Chia. Tsai, C. Hsu, S. Lei, J. Park, W. Han, “Sample adaptive offset in the HEVC standard,” IEEE Trans. Circuits Syst. Video Technol., 22(12): 1755-1764 (2012).

As illustrated, the input to a DBF may be the reconstructed image after intra or inter prediction, as shown with the output from the reconstruction block. The DBF performs detection of the artifacts at the coded block boundaries and attenuates the artifacts by applying a selected filter. Compared to the H.264/AVC deblocking filter, the HEVC deblocking filter has lower computational complexity and better parallel processing capabilities while still achieving significant reduction of the visual artifacts. For additional examples, see A. Norkin, G. Bjontegaard, A. Fuldseth, M. Narroschke, M. Ikeda, K. Andersson, Minhua Zhou, G. Van der Auwera, “HEVC Deblocking Filter,” IEEE Trans. Circuits Syst. Video Technol., 22(12): 1746-1754 (2012).

In HEVC, the deblocking filter decisions are made separately for each boundary of four-sample length that lies on the grid dividing the picture into blocks of 8×8 samples. Deblocking is performed on a block boundary if the following conditions are true: (1) the block boundary is a prediction unit (PU) or transform unit (TU) boundary; (2) the boundary strength (Bs), as defined in Table 1 below, is greater than zero; (3) variation of signal, as defined in Equation (1) below, on both sides of a block boundary is below a specified threshold.

TABLE 1
Boundary strength (Bs) values for boundaries between two
neighboring luma blocks

| Conditions | Bs |
|---|---|
| At least one of the blocks is Intra | 2 |
| At least one of the blocks has non-zero coded residual | 1 |
| coefficient and boundary is a transform boundary | |
| Absolute differences between corresponding spatial | 1 |
| motion vector components of the two blocks are >= 1 in | |
| units of integer pixels | |
| Motion-compensated prediction for the two blocks refers | 1 |
| to different reference pictures or the number of motion | |
| vectors is different for the two blocks | |
| Otherwise | 0 |

If Bs>0 for a luma block boundary, then the deblocking filtering is applied to that boundary the following condition holds:

|p_{2,0}−2p_{1,0}+p_{0,0}|+|p_{2,3}−2p_{1,3}+p_{0,3}|+|q_{2,0}−2q_{1,0}+q_{0,0}|+|q_{2,3}−2q_{1,3}+q_{0,3}|<β (1)

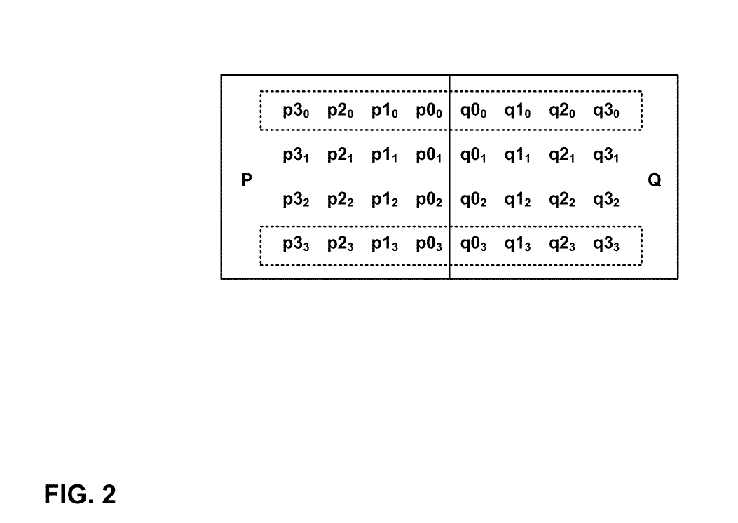

FIG. 2 is a conceptual diagram illustrating DBF across a vertical block boundary. In Equation (1) above, the terms p_{i,j} and q_{i,j} denote the pixels in column i and row j on either side of the block boundary as shown in FIG. 2. FIG. 2 illustrates a four-pixel long vertical block boundary. Deblocking decisions in HEVC are based on lines marked with the dashed line (lines 0 and 3) in FIG. 2. (See “HEVC Deblocking Filter” by Norkin et al (2012) above for details). Threshold β depends on the quantization parameter used for quantizing prediction error transform coefficients. The above condition applies to a vertical block boundary. Conditions for filtering a horizontal block boundary can be written or expressed similarly.

HEVC allows for two types luma deblocking filters, namely: (1) normal filter (2) strong filter. The choice of deblocking filter depends on whether particular signal variation terms (which are a function of the pixels shown in FIG. 2) are less than certain thresholds (see “HEVC Deblocking Filter” by Norkin et al (2012) cited above for details). Although the filtering decisions are based only on the two rows (columns) of a four pixel long vertical (or horizontal, as the case may be) boundary, the filter is applied to every row (or column, as the case may be) in the boundary. The number of pixels used in the filtering process and the number of pixels that may be modified with each type of filtering is summarized in Table 2 below.

TABLE 2
Number of pixels used/modified per boundary in HEVC deblocking

| | Pixels used | Pixels modified |
|---|---|---|
| | (on either side of | (on either side of |
| | boundary) | boundary) |
| Normal filter | 3 or 2 | 2 or 1 |
| Strong filter | 4 | 3 |

Chroma deblocking is performed only when Bs equals two (2). Only one type of chroma deblocking filter is used. The chroma deblocking filter uses pixels p₀, p₁, q₀, q₁ and may modify pixels p₀ and q₀ in each row (the second subscript indicating the row index is omitted in the above description for brevity, because the filter is applied to every row). In JEM, deblocking is performed at CU level. The size of CUs on either side of a boundary can be larger than 8×8. The minimum CU size is in JEM is 4×4. Therefore, deblocking filter may also be applied to boundaries of 4×4 blocks.

The input to SAO may be the reconstructed image after invoking deblocking filtering, as shown with the output from the deblocking filter. The concept of SAO is to reduce mean sample distortion of a region by first classifying the region samples into multiple categories with a selected classifier, obtaining an offset for each category, and then adding the offset to each sample of the category, where the classifier index and the offsets of the region are coded in the bitstream. In HEVC, the region (the unit for SAO parameters signaling) is defined to be a CTU.

Two SAO types that can satisfy the requirements of low complexity are adopted in HEVC. Those two types are edge offset (EO) and band offset (BO), which are discussed in further detail below. An index of an SAO type is coded (which is in the range of [0, 2]). For EO, the sample classification is based on comparison between current samples and neighboring samples according to 1-D directional patterns: horizontal, vertical, 135° diagonal, and 45° diagonal.

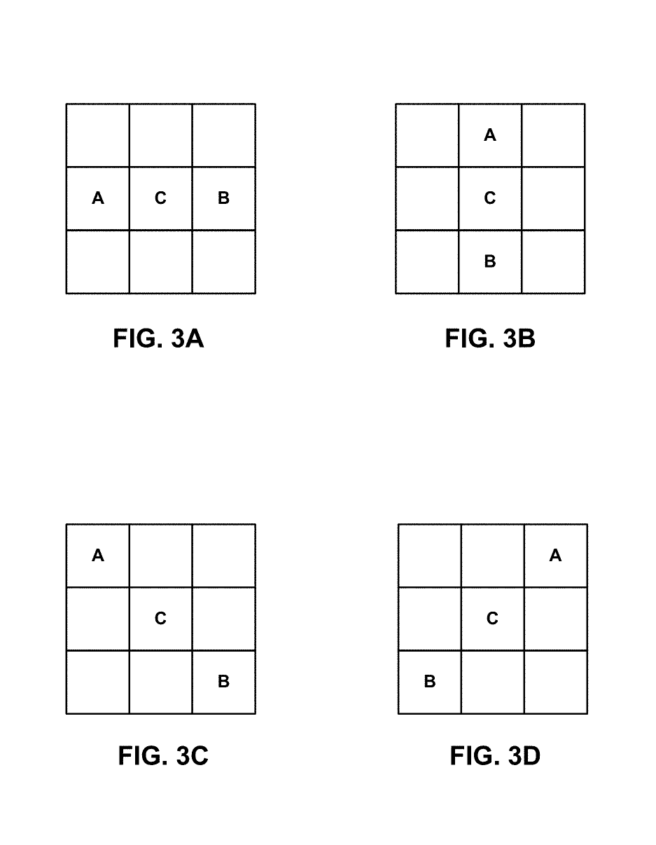

FIGS. 3A-3D show four 1-D directional patterns for EO sample classification: horizontal (FIG. 3A, EO class=0), vertical (FIG. 3B, EO class=1), 135° diagonal (FIG. 3C, EO class=2), and 45° diagonal (FIG. 3D, EO class=3). Additional details related to SAO are described in C. Fu, E. Alshina, A. Alshin, Y. Huang, C. Chen, Chia. Tsai, C. Hsu, S. Lei, J. Park, W. Han, “Sample adaptive offset in the HEVC standard,” IEEE Trans. Circuits Syst. Video Technol., 22(12): 1755-1764 (2012).

According to the selected EO pattern, five categories denoted by edgeIdx in Table I are further defined. For edgeIdx equal to 0˜3, the magnitude of an offset may be signaled while the sign flag is implicitly coded, i.e., negative offset for edgeIdx equal to 0 or 1 and positive offset for edgeIdx equal to 2 or 3. For edgeIdx equal to 4, the offset is always set to 0 which means no operation is required for this case.

TABLE I
classification for EO

| Category | |
|---|---|
| (edgeIdx) | Condition |
| 0 | c < a && c < b |
| 1 | (c < a && c==b ) \|\| (c==a && c<b) |
| 2 | (c > a && c==b) \|\| (c == a && c > b) |
| 3 | c > a && c > b |
| 4 | None of the above |

For BO, the sample classification is based on sample values. Each color component may have its own SAO parameters for classification for BO type SAO filtering. BO implies one offset is added to all samples of the same band. The sample value range is equally divided into 32 bands. For 8-bit samples ranging from 0 to 255, the width of a band is 8, and sample values from 8k to 8k+7 belong to band k, where k ranges from 0 to 31. The average difference between the original samples and reconstructed samples in a band (i.e., offset of a band) is signaled to the decoder (e.g., video decoder 30). There is no constraint on offset signs. Only offsets of four (4) consecutive bands and the starting band position are signaled to the decoder (e.g., video decoder 30).

For signaling of side information, to reduce side information, multiple CTUs can be merged together (either copying the parameters from above CTU (through setting sao_merge_left_flag equal to 1) or left CTU (through setting sao_merge_up_flag equal to 1)) to share SAO parameters.

### Syntax Tables

Coding Tree Unit Syntax

| coding_tree_unit( ) { | Descriptor |
|---|---|
| xCtb = ( CtbAddrInRs % PicWidthInCtbsY ) << | |
| CtbLog2SizeY | |
| yCtb = ( CtbAddrInRs / PicWidthInCtbsY ) << | |
| CtbLog2SizeY | |
| if( slice_sao_luma_flag \|\| slice_sao_chroma_flag ) | |
| sao( xCtb >> CtbLog2SizeY, yCtb >> CtbLog2SizeY ) | |
| coding_quadtree( xCtb, yCtb, CtbLog2SizeY, 0 ) | |
| } | |

Sample Adaptive Offset Syntax

| sao( rx, ry ) { | Descriptor |
|---|---|
| if( rx > 0 ) { | |
| leftCtbInSliceSeg = CtbAddrInRs > SliceAddrRs | |
| leftCtbInTile = TileId[ CtbAddrInTs ] = = | |
| TileId[ CtbAddrRsToTs[ CtbAddrInRs − 1 ] ] | |
| if( leftCtbInSliceSeg && leftCtbInTile ) | |
| sao_merge_left_flag | ae(v) |
| } | |
| if( ry > 0 && !sao_merge_left_flag ) { | |
| upCtbInSliceSeg = | |
| ( CtbAddrInRs − PicWidthInCtbsY ) >= SliceAddrRs | |
| upCtbInTile = TileId[ CtbAddrInTs ] = = | |
| TileId[ CtbAddrRsToTs[ CtbAddrInRs − | |
| PicWidthInCtbsY ] ] | |
| if( upCtbInSliceSeg && upCtbInTile ) | |
| sao_merge_up_flag | ae(v) |
| } | |
| if( !sao_merge_up_flag && !sao_merge_left_flag ) | |
| for( cIdx = 0; cIdx < ( ChromaArrayType != 0 ? 3 : 1 ); | |
| cIdx++ ) | |
| if( ( slice_sao_luma_flag && cIdx = = 0 ) \|\| | |
| ( slice_sao_chroma_flag && cIdx > 0 ) ) { | |
| if( cIdx = = 0 ) | |
| sao_type_idx_luma | ae(v) |
| else if( cIdx == 1 ) | |
| sao_type_idx_chroma | ae(v) |
| if( SaoTypeIdx[ cIdx ][ rx ][ ry ] != 0 ) { | |
| for( i = 0; i < 4; i++ ) | |
| sao_offset_abs[ cIdx ][ rx ][ ry ][ i ] | ae(v) |
| if( SaoTypeIdx[ cIdx ][ rx ][ ry ] = = 1 ) { | |
| for( i = 0; i < 4; i++ ) | |
| if( sao_offset_abs[ cIdx ][ rx ][ ry ] | |
| [ i ] != 0 ) | |
| sao_offset_sign[ cIdx ][ rx ][ ry ][ i ] | ae(v) |
| sao_band_position[ cIdx ][ rx ][ ry ] | ae(v) |
| } else { | |
| if( cIdx = = 0 ) | |
| sao_eo_class_luma | ae(v) |
| if( cIdx == 1 ) | |
| sao_eo_class_chroma | ae(v) |
| } | |
| } | |
| } | |
| } | |

### Semantics

sao_merge_left_flag equal to 1 specifies that the syntax elements sao_type_idx_luma, sao_type_idx_chroma, sao_band_position, sao_eo_class_luma, sao_eo_class_chroma, sao_offset_abs, and sao_offset_sign are derived from the corresponding syntax elements of the left coding tree block. sao_merge_left_flag equal to 0 specifies that these syntax elements are not derived from the corresponding syntax elements of the left coding tree block. When sao_merge_left_flag is not present, it is inferred to be equal to 0.
sao_merge_up_flag equal to 1 specifies that the syntax elements sao_type_idx_luma, sao_type_idx_chroma, sao_band_position, sao_eo_class_luma, sao_eo_class_chroma, sao_offset_abs, and sao_offset_sign are derived from the corresponding syntax elements of the above coding tree block. sao_merge_up_flag equal to 0 specifies that these syntax elements are not derived from the corresponding syntax elements of the above coding tree block. When sao_merge_up_flag is not present, it is inferred to be equal to 0.
sao_type_idx_luma specifies the offset type for the luma component. The array SaoTypeIdx[cIdx][rx][ry] specifies the offset type as specified in Table 7-8 for the coding tree block at the location (rx, ry) for the colour component cIdx. The value of SaoTypeIdx[0][rx][ry] is derived as follows:
If sao_type_idx_luma is present, SaoTypeIdx[0][rx][ry] is set equal to sao_type_idx_luma.
Otherwise (sao_type_idx_luma is not present), SaoTypeIdx[0][rx][ry] is derived as follows:
   If sao_merge_left_flag is equal to 1, SaoTypeIdx[0][rx][ry] is set equal to SaoTypeIdx[0][rx−1][ry].
   Otherwise, if sao_merge_up_flag is equal to 1, SaoTypeIdx[0][rx][ry] is set equal to SaoTypeIdx[0][rx][ry−1].
   Otherwise, SaoTypeIdx[0][rx][ry] is set equal to 0.
      sao_type_idx_chroma specifies the offset type for the chroma components. The values of SaoTypeIdx[cIdx][rx][ry] are derived as follows for cIdx equal to 1 . . . 2:
If sao_type_idx_chroma is present, SaoTypeIdx[cIdx][rx][ry] is set equal to sao_type_idx_chroma.
Otherwise (sao_type_idx_chroma is not present), SaoTypeIdx[cIdx][rx][ry] is derived as follows:
   If sao_merge_left_flag is equal to 1, SaoTypeIdx[cIdx][rx][ry] is set equal to SaoTypeIdx[cIdx][rx−1][ry].
   Otherwise, if sao_merge_up_flag is equal to 1, SaoTypeIdx[cIdx][rx][ry] is set equal to SaoTypeIdx[cIdx][rx][ry−1].
   Otherwise, SaoTypeIdx[cIdx][rx][ry] is set equal to 0.

TABLE 7-8
Specification of the SAO type

| | SAO type |
|---|---|
| SaoTypeIdx[ cIdx ][ rx ][ ry ] | (informative) |
| 0 | Not applied |
| 1 | Band offset |
| 2 | Edge offset |

sao_offset_abs[cIdx][rx][ry][i] specifies the offset value of i-th category for the coding tree block at the location (rx, ry) for the colour component cIdx.

When sao_offset_abs[cIdx][rx][ry][i] is not present, it is inferred as follows:
If sao_merge_left_flag is equal to 1, sao_offset_abs[cIdx][rx][ry][i] is inferred to be equal to sao_offset_abs[cIdx][rx−1][ry][i].
Otherwise, if sao_merge_up_flag is equal to 1, sao_offset_abs[cIdx][rx][ry][i] is inferred to be equal to sao_offset_abs[cIdx][rx][ry−1][i].
Otherwise, sao_offset_abs[cIdx][rx][ry][i] is inferred to be equal to 0.
   sao_offset_sign[cIdx][rx][ry][i] specifies the sign of the offset value of i-th category for the coding tree block at the location (rx, ry) for the colour component cIdx.

When sao_offset_sign[cIdx][rx][ry][i] is not present, it is inferred as follows:
If sao_merge_left_flag is equal to 1, sao_offset_sign[cIdx][rx][ry][i] is inferred to be equal to sao_offset_sign[cIdx][rx−1][ry][i].
Otherwise, if sao_merge_up_flag is equal to 1, sao_offset_sign[cIdx][rx][ry][i] is inferred to be equal to sao_offset_sign[cIdx][rx][ry−1][i].
Otherwise, if SaoTypeIdx[cIdx][rx][ry] is equal to 2, the following applies:
   If i is equal to 0 or 1, sao_offset_sign[cIdx][rx][ry][i] is inferred to be equal 0.
   Otherwise (i is equal to 2 or 3), sao_offset_sign[cIdx][rx][ry][i] is inferred to be equal 1.
Otherwise, sao_offset_sign[cIdx][rx][ry][i] is inferred to be equal 0.

The variable log 2OffsetScale is derived as follows:
If cIdx is equal to 0, log 2OffsetScale is set equal to log 2_sao_offset_scale_luma.
Otherwise (cIdx is equal to 1 or 2), log 2OffsetScale is set equal to log 2_sao_offset_scale_chroma.

The list SaoOffsetVal[cIdx][rx][ry][i] for i ranging from 0 to 4, inclusive, is derived as follows:

SaoOffsetVal[cIdx][rx][ry][0]=0

for (i=0; i<4; i++)

SaoOffsetVal[cIdx][rx][ry][i+1]=(1−2*sao_offset_sign[cIdx][rx][ry][i])*sao_offset_abs[cIdx][rx][ry][i]<<log 2OffsetScale (7-72)

sao_band_position[cIdx][rx][ry] specifies the displacement of the band offset of the sample range when SaoTypeIdx[cIdx][rx][ry] is equal to 1.

When sao_band_position[cIdx][rx][ry] is not present, it is inferred as follows:
If sao_merge_left_flag is equal to 1, sao_band_position[cIdx][rx][ry] is inferred to be equal to sao_band_position[cIdx][rx−1][ry].
Otherwise, if sao_merge_up_flag is equal to 1, sao_band_position[cIdx][rx][ry] is inferred to be equal to sao_band_position[cIdx][rx][ry−1].
Otherwise, sao_band_position[cIdx][rx][ry] is inferred to be equal to 0.
   sao_eo_class_luma specifies the edge offset class for the luma component. The array SaoEoClass[cIdx][rx][ry] specifies the offset type as specified in Table 7-9 for the coding tree block at the location (rx, ry) for the colour component cIdx. The value of SaoEoClass[0][rx][ry] is derived as follows:
If sao_eo_class_luma is present, SaoEoClass[0][rx][ry] is set equal to sao_eo_class_luma.
Otherwise (sao_eo_class_luma is not present), SaoEoClass[0][rx][ry] is derived as follows:
   If sao_merge_left_flag is equal to 1, SaoEoClass[0][rx][ry] is set equal to SaoEoClass[0][rx−1][ ry].
   Otherwise, if sao_merge_up_flag is equal to 1, SaoEoClass[0][rx][ry] is set equal to SaoEoClass[0][rx][ry−1].
   Otherwise, SaoEoClass[0][rx][ry] is set equal to 0.
      sao_eo_class_chroma specifies the edge offset class for the chroma components. The values of SaoEoClass[cIdx][rx][ry] are derived as follows for cIdx equal to 1 . . . 2:
If sao_eo_class_chroma is present, SaoEoClass[cIdx][rx][ry] is set equal to sao_eo_class_chroma.
Otherwise (sao_eo_class_chroma is not present), SaoEoClass[cIdx][rx][ry] is derived as follows:
   If sao_merge_left_flag is equal to 1, SaoEoClass[cIdx][rx][ry] is set equal to SaoEoClass[cIdx][rx−1][ry].
   Otherwise, if sao_merge_up_flag is equal to 1, SaoEoClass[cIdx][rx][ry] is set equal to SaoEoClass[cIdx][rx][ry−1].
   Otherwise, SaoEoClass[cIdx][rx][ry] is set equal to 0.

TABLE 7-9
Specification of the SAO edge offset class

| | SAO edge offset class |
|---|---|
| SaoEoClass[ cIdx ][ rx ][ ry ] | (informative) |
| 0 | 1D 0-degree edge offset |
| 1 | 1D 90-degree edge offset |
| 2 | 1D 135-degree edge offset |
| 3 | 1D 45-degree edge offset |

Video encoder 20 and video decoder 30 may be configured to implement various JEM filter filtering techniques. Aspects of those JEM filtering techniques will now be described. In addition to the modified DB and HEVC SAO methods, JEM has included another filtering method, called Geometry transformation-based Adaptive Loop Filtering (GALF). GALF aims to improve the coding efficiency of ALF studied in the HEVC stage by introducing several new aspects. ALF is aiming to minimize the mean square error between original samples and decoded samples by using Wiener-based adaptive filter. Samples in a picture are classified into multiple categories and the samples in each category are then filtered with their associated adaptive filter. The filter coefficients may be signaled or inherited to optimize the trade off between the mean square error and the overhead. The Geometry transformation-based ALF (GALF) scheme was proposed to further improve the performance of ALF, which introduces geometric transformations, such as rotation, diagonal and vertical flip, to be applied to the samples in filter support region depending on the orientation of the gradient of the reconstructed samples before ALF.

The input to ALF/GALF may be the reconstructed image after invoking SAO. As described in M. Karczewicz, L. Zhang, W.-J. Chien, X. Li, “EE2.5: Improvements on adaptive loop filter,” Exploration Team (JVET) of ITU-T SG 16 WP 3 and ISO/IEC JTC 1/SC 29/WG 11, Doc. JVET-B0060, 2^{nd} Meeting: San Diego, USA, 20 Feb.-26 Feb. 2016 and M. Karczewicz, L. Zhang, W.-J. Chien, X. Li, “EE2.5: Improvements on adaptive loop filter,” Exploration Team (JVET) of ITU-T SG 16 WP 3 and ISO/IEC JTC 1/SC 29/WG 11, Doc. JVET-00038, 3^{rd} Meeting: Geneva, CH, 26 May-1 Jun. 2016, the Geometric transformations-based ALF (GALF) was proposed. GALF has been adopted into JEM3.0. In GALF, the classification is modified with the diagonal gradients taken into consideration and geometric transformations could be applied to filter coefficients. Each 2×2 block is categorized into one out of 25 classes, based on the respective block's directionality and quantized value of activity. The details are described below.

Video encoder 20 and video decoder 30 may be configured to predict filters from fixed filters. In addition, to improve coding efficiency when temporal prediction is not available (intra frames), a set of 16 fixed filters is assigned to each class. To indicate the usage of the fixed filter, a flag for each class is signaled and if required, the index of the chosen fixed filter. Even when the fixed filter is selected for a given class, the coefficients of the adaptive filter f(k, l) can still be sent for this class in which case the coefficients of the filter which will be applied to the reconstructed image are sum of both sets of coefficients. Number of classes can share the same coefficients f(k, l) signaled in the bitstream even if different fixed filters were chosen for them. As explained in U.S. Provisional Patent Application 62/295,461 filed 15 Feb. 2016 and U.S. Provisional Patent Application 62/324,776 filed 19 Apr. 2016, fixed filters may also be applied to inter-coded frames.

Video encoder 20 and video decoder 30 may be configured to perform temporal prediction of filter coefficients. Aspects of temporal prediction of filter coefficients will now be described. The ALF coefficients of reference pictures are stored and allowed to be reused as ALF coefficients of a current picture. The current picture may choose to use ALF coefficients stored for the reference pictures, and bypass the ALF coefficients signalling. In this case, only an index to one of the reference pictures is signalled, and the stored ALF coefficients of the indicated reference picture are simply inherited for the current picture. To indicate the usage of temporal prediction, video encoder 20 may first encode one flag before sending the index (e.g., by signaling the same to video decoder 30).

The decoding flow of hardware implementation is now discussed. Because there is a dependency on neighboring blocks in the DB design, the decoding process for DB is not fully aligned with the LCU. An example is given as follows. The picture width and height are denoted as PicW and PicH respectively, and the LCU size is denoted as W*W.

For the first LCU, video decoder 30 may filter only part of the LCU in the DB process, because DB relies on neighboring blocks (e.g., the right neighboring block when filtering the right vertical boundary, and the below-neighboring block when filtering the bottom horizontal boundary). As for the current DB process, the neighboring four lines (columns for a vertical boundary and rows for a horizontal boundary) are required to filter the current LCU. Denote the number of lines required for filtering current LCU by T (T is equal to four in HEVC DB). The DB processed unit size (width, height) is calculated as follows:

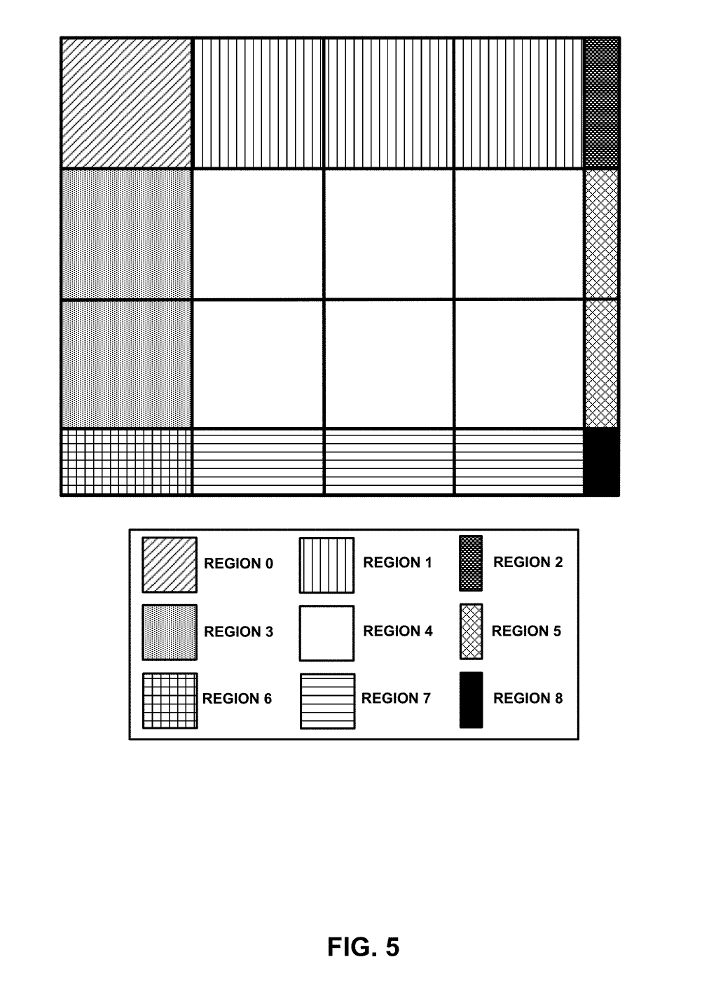

1. If the current LCU is in the first LCU row:
a. If the current LCU is the first LCU in a slice (region 0 in FIG. 5 described below), DB processed size is set to (W−T)*(W−T);
b. Else if the current LCU is not the last LCU (region 1 in FIG. 5 described below), DB processed size is set to W*(W−T);
c. else if (last LCU (region 2 in FIG. 5 described below)), DB processed size is set to (min (W+T, (PicW % W)+T)))*(W−T);

2. else if the current LCU is in the last LCU row, the following may apply:
a. if the current LCU is the first LCU (region 6 in FIG. 5 described below), DB processed size is set to (W−T)*(min (W+T, (PicH % W)+T)));
b. Else if the current LCU is not the last CTU (region 7 in FIG. 5 described below), DB processed size is set to W*(min (W+T, (PicH % W)+T)));
c. else if (last LCU (region 8 in FIG. 5 described below)), DB processed size is set to (min (W+T, (PicW % W)+T)))*(min (W+T, (PicH % W)+T)));

3. else (for the other remaining LCU rows), the following apply:
a. if the current LCU is the first LCU (region 3 in FIG. 5 described below), DB processed size is set to (W−T)*W;
b. Else if the current LCU is not the last CTU (region 4 in FIG. 5 described below), DB processed size is set to W*W;
c. else if (last LCU (region 5 in FIG. 5 described below)), DB processed size is set to (min (W+T, (PicW % W)+T)))*W;

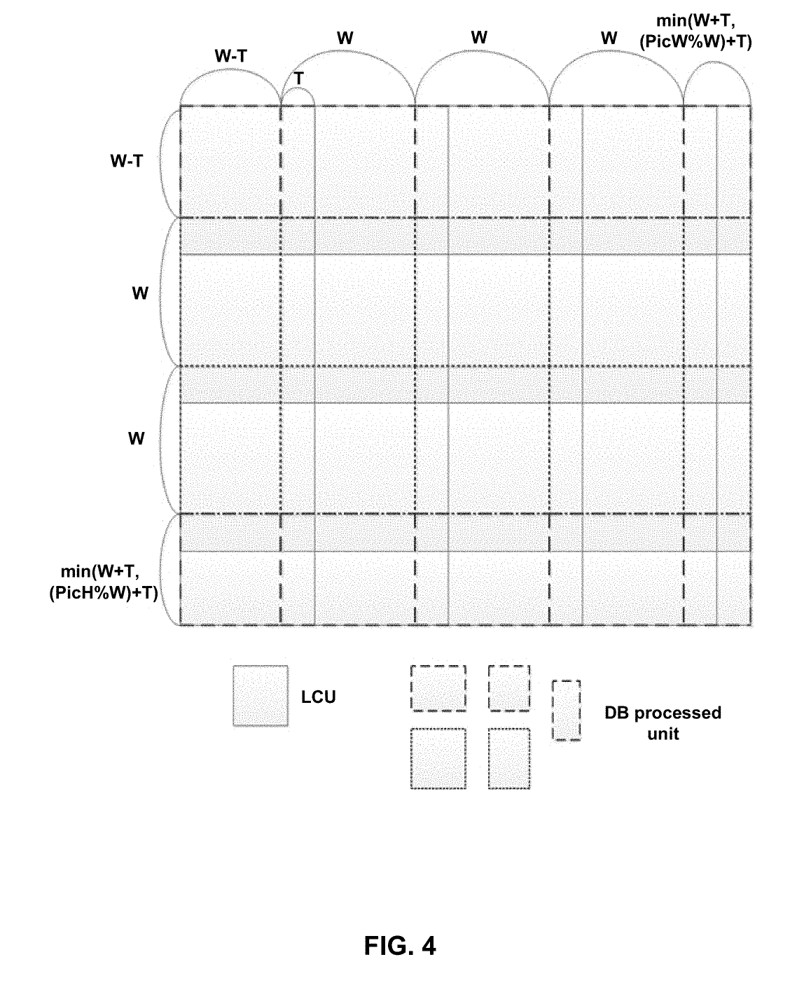

FIG. 4 is a conceptual diagram illustrating largest coding units and deblock-processed units. In FIG. 4, LCUs are denoted by solid lines (with size equal to W*W) and DB processed units are denoted by dash lines (DB processed unit size is variable).

FIG. 5 is a conceptual diagram illustrating a slice with multiple regions. Each region of the slice illustrated in FIG. 5 contains one or more LCUs.

The design of SAO and ALF/GALF may present one or more potential problems. As one example, on the encoder side, ALF/GALF is performed at whole slice/frame level (e.g., slice-wide-level or frame-wide-level), where the statistics from the whole slice/image is utilized for deriving filter parameters. As another example, for LCU-level ALF/GALF design, the filtering process in done LCU-by-LCU, which is not aligned with DB. Therefore, additional delay may be caused. As another example, similarly, for the LCU-level SAO, the filtering process in done LCU-by-LCU, which is not aligned with DB.

To mitigate or potentially solve one or more of the problems discussed above, this disclosure describes techniques to make other filters (e.g., SAO and ALF), other than deblocking filters amenable to efficient hardware implementations. Video encoder 20 and/or video decoder 30 may apply any of the following itemized techniques individually. Alternatively, video encoder 20 and/or video decoder 30 may apply any combination of the itemized techniques discussed below. For purposes of explanation, the picture width and height are denoted by PicW and PicH respectively, and LCU size is denotes LcuW*LcuH. The number of right columns required for filtering current LCU vertical boundary is denoted by VT (VT is equal to four (4) in HEVC DB), and the number of rows above required by filtering current LCU horizontal boundary is denoted by HT (HT is equal to four (4) in HEVC DB).

According to some techniques of this disclosure, video encoder 20 may perform the signaling of filter information (e.g., filter coefficients, on/off control flags, indications of filter support, etc.) at the region-level. However, the filtering process may apply to samples outside of current LCU. Video encoder 20 (e.g., by invoking filter unit 64) may apply the filtering process to a unit which is not fully aligned with the region.
i. In one example, the unit is aligned with what the DB could directly handle without waiting for other LCUs.
ii. In one example, the region is defined as an LCU. In some examples, the region may be defined as multiple consecutive LCUs.
iii. The unit size may be derived as follows (taking the region size equal to LCU as an example):
   If the current LCU is in the first LCU row, the following may apply:
      a) If the current LCU is the first LCU in a slice or a tile or wavefront, the unit sizes of other filters is set to (LcuW−VT)*(LcuH−HT);
      b) Else if the current LCU is not the last LCU in a slice or a tile or wavefront, the unit size is set to LcuW*(LcuH−HT);
      c) else if (last LCU), the unit size is set to (min (LcuW+VT, (PicW % LcuW)+VT)))*(LcuH−HT); In some examples, the unit size is set to (LcuW+VT)*(LcuH−HT);
   If the current LCU is in the last LCU row, the following apply:
      d) if the current LCU is the first LCU in a slice or a tile or wavefront, the unit size is set to (LcuW−VT)*(min (LcuH+HT, (PicH % LcuH)+HT))); In some examples, the unit size is set to (LcuW−VT)*(LcuH+HT)
      e) Else if the current LCU is not the last LCU in a slice or a tile or wavefront, the unit size is set to LcuW*(min (LcuH+HT, (PicH % LcuH)+HT))); In some examples, the unit size is set to LcuW*(LcuH+HT);
      f) else if (last LCU), the unit size is set to (min (LcuW+VT, (PicW % LcuW)+VT)))*(min (LcuH+HT, (PicH % LcuH)+HT))); In some examples, the unit size is set to (min (LcuW+VT, (PicW % LcuW)+VT)))*(LcuH+HT); In some examples, the unit size is set to (LcuW+VT)*(min (LcuH+HT, (PicH % LcuH)+HT))); In some examples, the unit size is set to (LcuW+VT)*(LcuH+HT);
   For the other remaining LCU rows (neither the first nor the last row), the following apply:
      g) if the current LCU is the first LCU in a slice or a tile or wavefront, the unit size is set to (LcuW-VT)*LcuH;
      h) Else if the current LCU is not the last LCU in a slice or a tile or wavefront, the unit size is set to LcuW*LcuH;
      i) Else (the last LCU), the unit size is set to (min (LcuW+VT, (PicW % LcuW)+VT)))*LcuH;
iv. The top-left coordinate of the unit to perform filter relative to the slice/tile/wavefront may be derived based on the top-left coordinate of the region for signaling filter information.
   a) In one example, denote the top-left coordinate of the region for signaling filter information by (x, y), and the top-left coordinate of the unit for performing filter information is given by (max (0, x−VT), max(0, y−HT)).

According to some examples of this disclosure, video encoder 20 and/or video decoder 30 may unify the processing unit among multiple filters. In this case, video encoder 20 and/or video decoder 30 may set VT to the maximum value of the number of right columns required for filtering current LCU. Alternatively or in addition, video encoder 20 and/or video decoder 30 may set HT to the maximum value of the number of rows above required for filtering current LCU.
i. In one example, VT and/or HT may be changed from unit or unit. In some examples, VT and/or HT may depend on the derived/signaled filter support and/or filter decision procedure of one or multiple filters.
ii. In one example, multiple filters may be included, but not limited to DB, SAO, ALF, etc.

In some examples of this disclosure, video encoder 20 and/or video decoder 30 may apply one or more of the above-described techniques to Luma components, as well as chroma components.

In some examples of this disclosure, video encoder 20 may signal a flag in the bitstream to video decoder 30, such as by signaling the flag in one or more of a VPS/SPS/PPS, to indicate whether this unit based method is used or not.

Examples of the techniques of this disclosure are described below. For the LCU-based SAO and/or ALF, the following may apply: For each LCU, video encoder 20 and/or video decoder 30 may apply the following to derive the actual unit size and top-left coordinate relative to the slice/tile/wavefront for performing filtering. More specifically, denote the coordinate of a LCU by (x, y) relative to the top-left sample within the same slice/tile/wavefront:
If the current LCU is in the first LCU row:
   a. If the current LCU is the first LCU in a slice (region0 in FIG. 5), the unit size for performing SAO/ALF is set to (W−T)*(W−T) and the coordinate of the top-left sample is (x, y)
   b. else if the current LCU is not the last CTU (region1 in FIG. 5), the unit size for performing SAO/ALF is set to W*(W−T) and the coordinate of the top-left sample is (x−M, y)
   c. else if (last LCU (region2 in FIG. 5)), the unit size for performing SAO/ALF is set to (min (W+T, (PicW % W)+T)))*(W−T) and the coordinate of the top-left sample is (x-M, y);
else if the current LCU is in the last LCU row, the following apply:
   a. if the current LCU is the first LCU (region6 in FIG. 5), the unit size for performing SAO/ALF is set to (W−T)*(min (W+T, (PicH % W)+T))) and the coordinate of the top-left sample is (x, y−L);
   b. Else if the current LCU is not the last CTU (region7 in FIG. 5), the unit size for performing SAO/ALF is set to W*(min (W+T, (PicH % W)+T))) and the coordinate of the top-left sample is (x−M, y−L);
   c. else if (last LCU (region8 in FIG. 5)), the unit size for performing SAO/ALF is set to (min (W+T, (PicW % W)+T)))*(min (W+T, (PicH % W)+T))) and the coordinate of the top-left sample is (x−M, y−L);
else (for the other remaining LCU rows), the following apply:
   a. if the current LCU is the first LCU (region3 in FIG. 5), the unit size for performing SAO/ALF is set to (W−T)*W and the coordinate of the top-left sample is (x, y−L);
   b. Else if the current LCU is not the last CTU (region4 in FIG. 5), the unit size for performing SAO/ALFi s set to W*W and the coordinate of the top-left sample is (x−M, y−L);
   c. else if (last LCU (regions in FIG. 5)), the unit size for performing SAO/ALF is set to (min (W+T, (PicW % W)+T)))*W and the coordinate of the top-left sample is (x−M, y−L);

In the various examples, % represents the modulo operator, which gives the remainder following division.

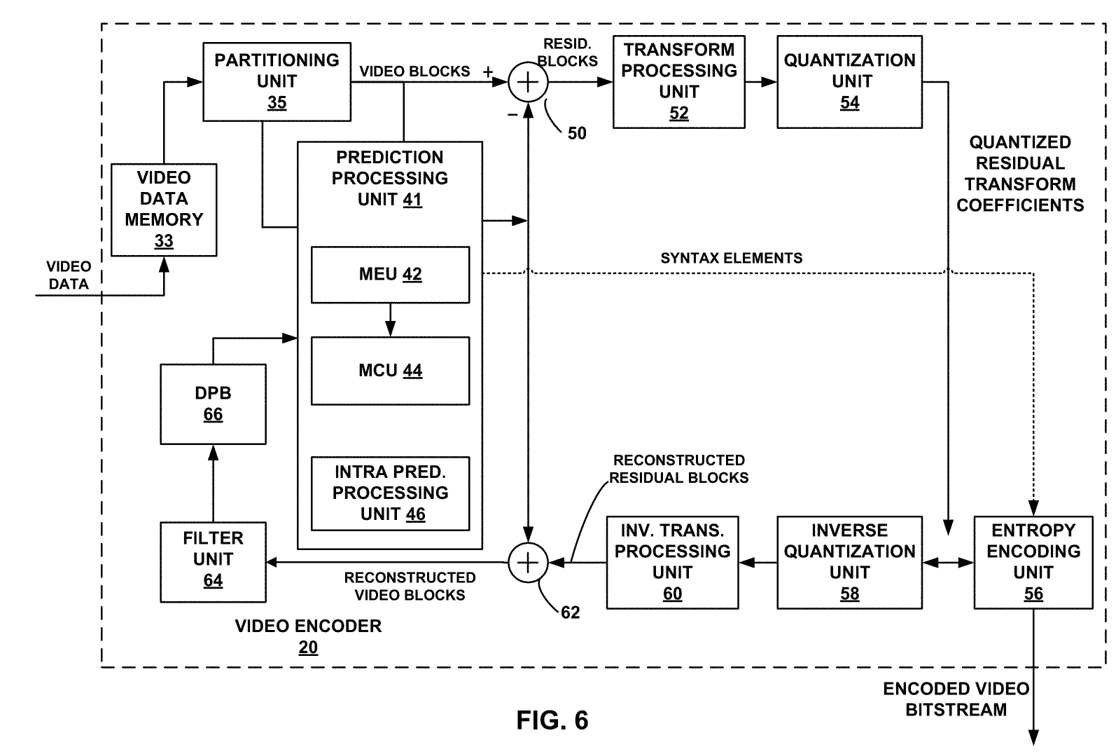

FIG. 6 is a block diagram illustrating an example video encoder 20 that may implement the techniques described in this disclosure. Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based compression modes. Inter-modes, such as uni-directional prediction (P mode) or bi-prediction (B mode), may refer to any of several temporal-based compression modes.

In the example of FIG. 6, video encoder 20 includes a video data memory 33, partitioning unit 35, prediction processing unit 41, summer 50, transform processing unit 52, quantization unit 54, entropy encoding unit 56. Prediction processing unit 41 includes motion estimation unit (MEU) 42, motion compensation unit (MCU) 44, and intra prediction unit 46. For video block reconstruction, video encoder 20 also includes inverse quantization unit 58, inverse transform processing unit 60, summer 62, filter unit 64, and decoded picture buffer (DPB) 66.

As shown in FIG. 6, video encoder 20 receives video data and stores the received video data in video data memory 33. Video data memory 33 may store video data to be encoded by the components of video encoder 20. The video data stored in video data memory 33 may be obtained, for example, from video source 18. DPB 66 may be a reference picture memory that stores reference video data for use in encoding video data by video encoder 20, e.g., in intra- or inter-coding modes. Video data memory 33 and DPB 66 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 33 and DPB 66 may be provided by the same memory device or separate memory devices. In various examples, video data memory 33 may be on-chip with other components of video encoder 20, or off-chip relative to those components.

Partitioning unit 35 retrieves the video data from video data memory 33 and partitions the video data into video blocks. This partitioning may also include partitioning into slices, tiles, or other larger units, as wells as video block partitioning, e.g., according to a quadtree structure of LCUs and CUs. Video encoder 20 generally illustrates the components that encode video blocks within a video slice to be encoded. The slice may be divided into multiple video blocks (and possibly into sets of video blocks referred to as tiles). Prediction processing unit 41 may select one of a plurality of possible coding modes, such as one of a plurality of intra coding modes or one of a plurality of inter coding modes, for the current video block based on error results (e.g., coding rate and the level of distortion). Prediction processing unit 41 may provide the resulting intra- or inter-coded block to summer 50 to generate residual block data and to summer 62 to reconstruct the encoded block for use as a reference picture.

Intra prediction unit 46 within prediction processing unit 41 may perform intra-predictive coding of the current video block relative to one or more neighboring blocks in the same frame or slice as the current block to be coded to provide spatial compression. Motion estimation unit 42 and motion compensation unit 44 within prediction processing unit 41 perform inter-predictive coding of the current video block relative to one or more predictive blocks in one or more reference pictures to provide temporal compression.

Motion estimation unit 42 may be configured to determine the inter-prediction mode for a video slice according to a predetermined pattern for a video sequence. The predetermined pattern may designate video slices in the sequence as P slices or B slices. Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference picture.

A predictive block is a block that is found to closely match the PU of the video block to be coded in terms of pixel difference, which may be determined by sum of absolute difference (SAD), sum of square difference (SSD), or other difference metrics. In some examples, video encoder 20 may calculate values for sub-integer pixel positions of reference pictures stored in DPB 66. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in DPB 66. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation, possibly performing interpolations to sub-pixel precision. Upon receiving the motion vector for the PU of the current video block, motion compensation unit 44 may locate the predictive block to which the motion vector points in one of the reference picture lists. Video encoder 20 forms a residual video block by subtracting pixel values of the predictive block from the pixel values of the current video block being coded, forming pixel difference values. The pixel difference values form residual data for the block, and may include both luma and chroma difference components. Summer 50 represents the component or components that perform this subtraction operation. Motion compensation unit 44 may also generate syntax elements associated with the video blocks and the video slice for use by video decoder 30 in decoding the video blocks of the video slice.

After prediction processing unit 41 generates the predictive block for the current video block, either via intra prediction or inter prediction, video encoder 20 forms a residual video block by subtracting the predictive block from the current video block. The residual video data in the residual block may be included in one or more TUs and applied to transform processing unit 52. Transform processing unit 52 transforms the residual video data into residual transform coefficients using a transform, such as a discrete cosine transform (DCT) or a conceptually similar transform. Transform processing unit 52 may convert the residual video data from a pixel domain to a transform domain, such as a frequency domain.

Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. In another example, entropy encoding unit 56 may perform the scan.

Following quantization, entropy encoding unit 56 entropy encodes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy encoding methodology or technique. Following the entropy encoding by entropy encoding unit 56, the encoded bitstream may be transmitted to video decoder 30, or archived for later transmission or retrieval by video decoder 30. Entropy encoding unit 56 may also entropy encode the motion vectors and the other syntax elements for the current video slice being coded.

Inverse quantization unit 58 and inverse transform processing unit 60 apply inverse quantization and inverse transformation, respectively, to reconstruct the residual block in the pixel domain for later use as a reference block of a reference picture. Motion compensation unit 44 may calculate a reference block by adding the residual block to a predictive block of one of the reference pictures within one of the reference picture lists. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed block.

Filter unit 64 filters the reconstructed block (e.g. the output of summer 62) and stores the filtered reconstructed block in DPB 66 for uses as a reference block. The reference block may be used by motion estimation unit 42 and motion compensation unit 44 as a reference block to inter-predict a block in a subsequent video frame or picture. Filter unit 64 may perform any type of filtering such as deblock filtering, SAO filtering, peak SAO filtering, ALF, and/or GALF, and/or other types of loop filters. A deblock filter may, for example, apply deblocking filtering to filter block boundaries to remove blockiness artifacts from reconstructed video. A peak SAO filter may apply offsets to reconstructed pixel values in order to improve overall coding quality. Additional loop filters (in loop or post loop) may also be used.

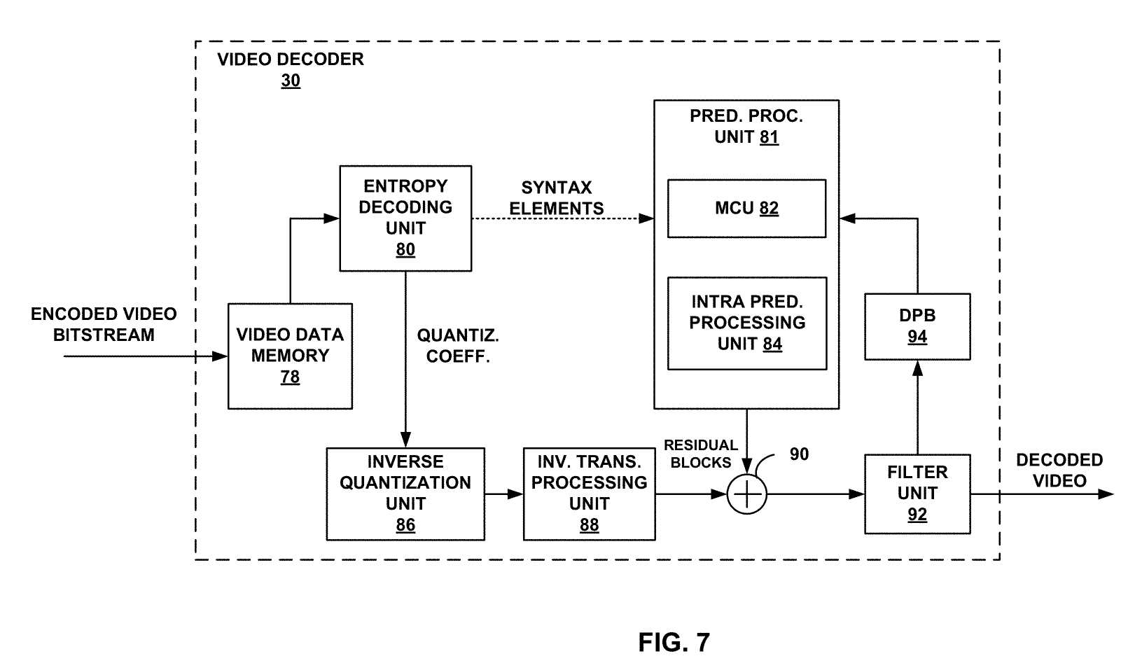

FIG. 7 is a block diagram illustrating an example video decoder 30 that may implement the techniques described in this disclosure. Video decoder 30 of FIG. 7 may, for example, be configured to receive the signaling described above with respect to video encoder 20 of FIG. 6. In the example of FIG. 7, video decoder 30 includes video data memory 78, entropy decoding unit 80, prediction processing unit 81, inverse quantization unit 86, inverse transform processing unit 88, summer 90, and DPB 94. Prediction processing unit 81 includes motion compensation unit 82 and intra prediction unit 84. Video decoder 30 may, in some examples, perform a decoding pass generally reciprocal to the encoding pass described with respect to video encoder 20 from FIG. 6.

During the decoding process, video decoder 30 receives an encoded video bitstream that represents video blocks of an encoded video slice and associated syntax elements from video encoder 20. Video decoder 30 stores the received encoded video bitstream in video data memory 78. Video data memory 78 may store video data, such as an encoded video bitstream, to be decoded by the components of video decoder 30. The video data stored in video data memory 78 may be obtained, for example, via link 16, from storage device 26, or from a local video source, such as a camera, or by accessing physical data storage media. Video data memory 78 may form a coded picture buffer (CPB) that stores encoded video data from an encoded video bitstream. DPB 94 may be a reference picture memory that stores reference video data for use in decoding video data by video decoder 30, e.g., in intra- or inter-coding modes. Video data memory 78 and DPB 94 may be formed by any of a variety of memory devices, such as DRAM, SDRAM, MRAM, RRAM, or other types of memory devices. Video data memory 78 and DPB 94 may be provided by the same memory device or separate memory devices. In various examples, video data memory 78 may be on-chip with other components of video decoder 30, or off-chip relative to those components.

Entropy decoding unit 80 of video decoder 30 entropy decodes the video data stored in video data memory 78 to generate quantized coefficients, motion vectors, and other syntax elements. Entropy decoding unit 80 forwards the motion vectors and other syntax elements to prediction processing unit 81. Video decoder 30 may receive the syntax elements at the video slice level and/or the video block level.

When the video slice is coded as an intra-coded (I) slice, intra prediction unit 84 of prediction processing unit 81 may generate prediction data for a video block of the current video slice based on a signaled intra prediction mode and data from previously decoded blocks of the current frame or picture. When the video frame is coded as an inter-coded slice (e.g., B slice or P slice), motion compensation unit 82 of prediction processing unit 81 produces predictive blocks for a video block of the current video slice based on the motion vectors and other syntax elements received from entropy decoding unit 80. The predictive blocks may be produced from one of the reference pictures within one of the reference picture lists. Video decoder 30 may construct the reference frame lists, List 0 and List 1, using default construction techniques based on reference pictures stored in DPB 94.

Motion compensation unit 82 determines prediction information for a video block of the current video slice by parsing the motion vectors and other syntax elements, and uses the prediction information to produce the predictive blocks for the current video block being decoded. For example, motion compensation unit 82 uses some of the received syntax elements to determine a prediction mode (e.g., intra- or inter-prediction) used to code the video blocks of the video slice, an inter-prediction slice type (e.g., B slice or P slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 82 may also perform interpolation based on interpolation filters. Motion compensation unit 82 may use interpolation filters as used by video encoder 20 during encoding of the video blocks to calculate interpolated values for sub-integer pixels of reference blocks. In this case, motion compensation unit 82 may determine the interpolation filters used by video encoder 20 from the received syntax elements and use the interpolation filters to produce predictive blocks.

Inverse quantization unit 86 inverse quantizes, i.e., de-quantizes, the quantized transform coefficients provided in the bitstream and decoded by entropy decoding unit 80. The inverse quantization process may include use of a quantization parameter calculated by video encoder 20 for each video block in the video slice to determine a degree of quantization and, likewise, a degree of inverse quantization that should be applied. Inverse transform processing unit 88 applies an inverse transform, e.g., an inverse DCT, an inverse integer transform, or a conceptually similar inverse transform process, to the transform coefficients in order to produce residual blocks in the pixel domain.

After prediction processing unit generates the predictive block for the current video block using, for example, intra or inter prediction, video decoder 30 forms a reconstructed video block by summing the residual blocks from inverse transform processing unit 88 with the corresponding predictive blocks generated by motion compensation unit 82. Summer 90 represents the component or components that perform this summation operation.

Filter unit 92 filters the reconstructed block (e.g. the output of summer 90) and stores the filtered reconstructed block in DPB 94 for uses as a reference block. The reference block may be used by motion compensation unit 82 as a reference block to inter-predict a block in a subsequent video frame or picture. Filter unit 92 may perform any type of filtering such as deblock filtering, SAO filtering, peak SAO filtering, ALF, and/or GALF, and/or other types of loop filters. A deblock filter may, for example, apply deblocking filtering to filter block boundaries to remove blockiness artifacts from reconstructed video. A peak SAO filter may apply offsets to reconstructed pixel values in order to improve overall coding quality. Additional loop filters (in loop or post loop) may also be used.

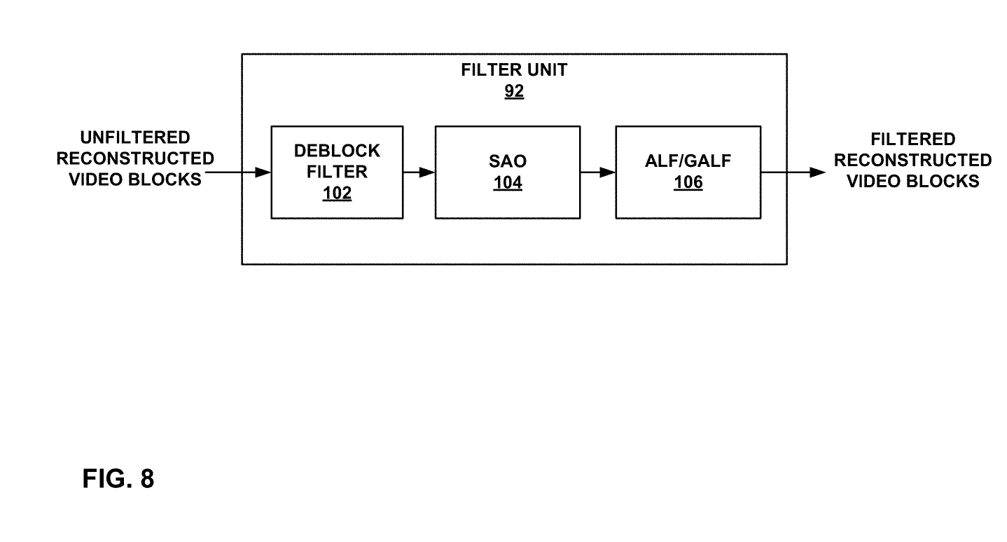

FIG. 8 shows an example implementation of filter unit 92. Filter unit 64 may be implemented in the same manner. Filter units 64 and 92 may perform the techniques of this disclosure, possibly in conjunction with other components of video encoder 20 or video decoder 30. In the example of FIG. 8, filter unit 92 includes deblock filter 102, SAO filter 104, and ALF/GLAF filter 106. SAO filter 104 may, for example, be configured to determine offset values for samples of a block in the manner described in this disclosure.

Filter unit 92 may include fewer filters and/or may include additional filters. Additionally, the particular filters shown in FIG. 8 may be implemented in a different order. Other loop filters (either in the coding loop or after the coding loop) may also be used to smooth pixel transitions or otherwise improve the video quality. The decoded video blocks in a given frame or picture are then stored in DPB 94, which stores reference pictures used for subsequent motion compensation. DPB 94 may be part of or separate from additional memory that stores decoded video for later presentation on a display device, such as display device 32 of FIG. 1.

Filter unit 92 and filter unit 64 may be configured to perform the techniques of this disclosure. For example, filter unit 92 and filter unit 64 may be configured to, as part of decoding video data, determine filter information for a region of a picture of video data; for a largest coding unit (LCU) of the region, determining a size for a current unit based on a location of the LCU within the picture, wherein the size for the current unit is different than a size of the LCU; based on the determined filter information, determining a filter for the current unit of the region; and filtering the current unit with the determined filter. Filter unit 64 may, for example, decode video data as part of determining how to encode video data.

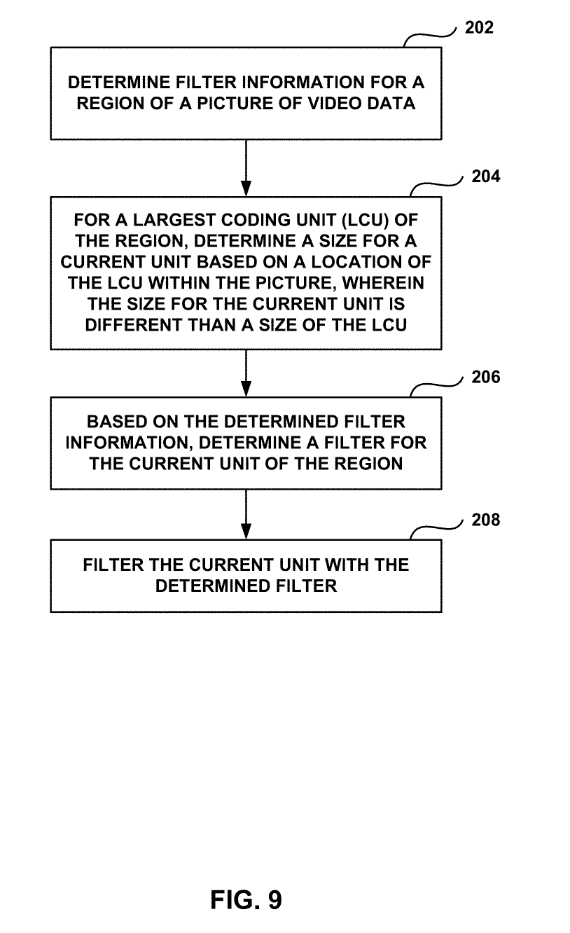

FIG. 9 is a flow diagram illustrating an example video decoding technique described in this disclosure. The techniques of FIG. 9 will be described with reference to a generic video decoder, such as but not limited to video decoder 30. In some instances, the techniques of FIG. 8 may be performed by a video encoder such as video encoder 20, in which case the generic video decoder corresponds to the decoding loop of the video encoder.

In the example of FIG. 9, the video decoder determines filter information for a region of a picture of video data (202). For a largest coding unit (LCU) of the region, The video decoder determines a size for a current unit based on a location of the LCU within the picture, the size for the current unit being different than a size of the LCU (204). Based on the determined filter information, the video decoder determines a filter for the current unit of the region (206). The video decoder filters the current unit with the determined filter (208).

To determine the size for the current unit, the video decoder may be configured to determine that the current unit is positioned in a first row of LCUs and, responsive to determining that the current unit is a first LCU in the first row of LCUs, set unit sizes for filters other than deblocking filters according to the formula (LcuW−VT)*(LcuH−HT). To determine the size for the current unit, the video decoder may be configured to determine that the current unit is positioned in a first row of LCUs and, responsive to determining the current unit is a last LCU in the first row of LCUs, setting the current unit size according to the formula (min (W+T, (PicW % W)+T)))*(W−T). To determine the size for the current unit, the video decoder may be configured to determine that the current unit is positioned in a first row of LCUs and, responsive to determining the current unit is neither the first LCU nor the last LCU in the first row of LCUs, setting the current unit size according to the formula W*(W−T).

To determine the size for the current unit, the video decoder may be configured to determine that the current unit is positioned in a last row of LCUs and, responsive to determine that the current unit is a first LCU in the last row of LCUs, setting the current unit size according to the formula (LcuW−VT)*(LcuH−HT). To determine the size for the current unit, the video decoder may be configured to determine that the current unit is positioned in a last row of LCUs and, responsive to determining the current unit is a last LCU in the last row of LCUs, setting the current unit size according to the formula W*(min (W+T, (PicH % W)+T))). To determine the size for the current unit, the video decoder may be configured to determine that the current unit is positioned in a last row of LCUs and, responsive to determining the current unit is neither the first LCU nor the last LCU in the last row of LCUs, setting the current unit size according to the formula (min (W+T, (PicW % W)+T)))*(min (W+T, (PicH % W)+T))).

To determine the size for the current unit, the video decoder may be configured to determine that the current unit is positioned in a row of LCUs that is neither a first row of LCUs nor a last row of LCUs and, responsive to determining that the current unit is a first LCU in the row of LCUs, setting the current unit size according to the formula (W−T)*W. To determine the size for the current unit, the video decoder may be configured to determine that the current unit is positioned in a row of LCUs that is neither a first row of LCUs nor a last row of LCUs and, responsive to determining the current unit is a last LCU in the row of LCUs, setting the current unit size according to the formula W*W. To determine the size for the current unit, the video decoder may be configured to determine that the current unit is positioned in a row of LCUs that is neither a first row of LCUs nor a last row of LCUs and, responsive to determining the current unit is neither the first LCU nor the last LCU in the row of LCUs, setting the current unit size according to the formula (min (W+T, (PicW % W)+T)))*W.

The video decoder outputs a decoded version of the current unit based on the filtering. In instances where the video decoder is part of a video encoder, then the video decoder may output the decoded version of the current unit by storing a decoded picture including the filtered current unit in a decoded picture buffer for use as a reference picture in encoding subsequent pictures of video data. In instances where the video decoder is decoding the video data for display, then the video decoder may output the decoded version of the current unit by storing a decoded picture, including the decoded version of the current unit, in a decoded picture buffer for use as reference picture in decoding subsequent pictures of video data and by outputting a decoded picture, including the decoded version of the current unit, to a display device.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can be any of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method for decoding video data, the method comprising:
determining filter information for a region of a picture of video data;
for a largest coding unit (LCU) of the region, determining a size for a current unit based on a location of the LCU within the picture, wherein the size for the current unit is different than a size of the LCU;
based on the determined filter information, determining a filter for the current unit of the region; and
filtering the current unit with the determined filter.

2. The method of claim 1, wherein the filter information comprises one or more of a filter coefficient, an on/off control flag, or an indication of filter support.

3. The method of claim 1, wherein the region corresponds to one or more largest coding units (LCUs).

4. The method of claim 1, wherein determining the size for the current unit comprises:
determining that the current unit is positioned in a first row of LCUs; and
responsive to determining that the current unit comprises a first LCU in the first row of LCUs, setting unit sizes for filters other than deblocking filters according to the formula (LcuW−VT)*(LcuH−HT), wherein LcuW is a width of the LCU, VT is a number of right columns needed to filter a left boundary of the LCU, LcuH is a height of the LCU, and HT is a number of above rows needed to filter a top boundary of the LCU.

5. The method of claim 1, wherein determining the size for the current unit comprises:
determining that the current unit is positioned in a first row of LCUs; and
responsive to determining the current unit comprises a last LCU in the first row of LCUs, setting the current unit size according to the formula (min (W+T, (PicW % W)+T)))*(W−T), wherein T is a number of lines required to filter the LCU, and W is a width of the LCU, and PicW is a width of the picture.

6. The method of claim 1, wherein determining the size for the current unit comprises:
determining that the current unit is positioned in a first row of LCUs; and
responsive to determining the current unit comprises neither the first LCU nor the last LCU in the first row of LCUs, setting the current unit size according to the formula W*(W−T), wherein T is a number of lines required to filter the LCU, and W is a width of the LCU.

7. The method of claim 1, wherein determining the size for the current unit comprises:
determining that the current unit is positioned in a last row of LCUs; and
responsive to determining that the current unit comprises a first LCU in the last row of LCUs, setting the current unit size according to the formula (LcuW−VT)*(LcuH−HT), wherein LcuW is a width of the LCU, VT is a number of right columns needed to filter a left boundary of the LCU, LcuH is a height of the LCU, and HT is a number of above rows needed to filter a top boundary of the LCU.

8. The method of claim 1, wherein determining the size for the current unit comprises:
determining that the current unit is positioned in a last row of LCUs; and
responsive to determining the current unit comprises a last LCU in the last row of LCUs, setting the current unit size according to the formula W*(min (W+T, (PicH % W)+T))), wherein PicH is a height of the picture, T is a number of lines required to filter the LCU, and W is a width of the LCU.

9. The method of claim 1, wherein determining the size for the current unit comprises:
determining that the current unit is positioned in a last row of LCUs; and
responsive to determining the current unit comprises neither the first LCU nor the last LCU in the last row of LCUs, setting the current unit size according to the formula (min (W+T, (PicW % W)+T)))*(min (W+T, (PicH % W)+T))) wherein PicH is a height of the picture, T is a number of lines required to filter the LCU, and W is a width of the LCU.

10. The method of claim 1, wherein determining the size for the current unit comprises:
determining that the current unit is positioned in a row of LCUs that comprises neither a first row of LCUs nor a last row of LCUs; and
responsive to determining that the current unit comprises a first LCU in the row of LCUs, setting the current unit size according to the formula (W−T)*W, wherein T is a number of lines required to filter the LCU, and W is a width of the LCU.

11. The method of claim 1, wherein determining the size for the current unit comprises:
determining that the current unit is positioned in a row of LCUs that is neither a first row of LCUs nor a last row of LCUs; and
responsive to determining the current unit comprises a last LCU in the row of LCUs, setting the current unit size according to the formula W*W, wherein W is a width and a height of the LCU.

12. The method of claim 1, wherein determining the size for the current unit comprises:
determining that the current unit is positioned in a row of LCUs that is neither a first row of LCUs nor a last row of LCUs; and
responsive to determining the current unit comprises neither the first LCU nor the last LCU in the row of LCUs, setting the current unit size according to the formula (min (W+T, (PicW % W)+T)))*W, wherein T is a number of lines required to filter the LCU, and W is a width of the LCU, and PicW is a width of the picture.

13. The method of claim 1, further comprising:
receiving a syntax element that indicates whether or not a unit-based filtering technique is applied to a current unit of the video data.

14. The method of claim 1, wherein the LCU comprises a coding tree unit.

15. A device for decoding video data, the device comprising:
a memory configured to store video data; and
one or more processors configured to:
determine filter information for a region of a picture of the video data;
for a largest coding unit (LCU) of the region, determine a size for a current unit based on a location of the LCU within the picture, wherein the size for the current unit is different than a size of the LCU;
based on the determined filter information, determine a filter for the current unit of the region; and
filter the current unit with the determined filter.

16. The device of claim 15, wherein the filter information comprises one or more of a filter coefficient, an on/off control flag, or an indication of filter support.

17. The device of claim 15, wherein the region corresponds to one or more largest coding units (LCUs).

18. The device of claim 15, wherein to determine the size for the current unit, the one or more processors are configured to:
determine that the current unit is positioned in a first row of LCUs; and
responsive to determining that the current unit comprises a first LCU in the first row of LCUs, set unit sizes for filters other than deblocking filters according to the formula (LcuW−VT)*(LcuH−HT), wherein LcuW is a width of the LCU, VT is a number of right columns needed to filter a left boundary of the LCU, LcuH is a height of the LCU, and HT is a number of above rows needed to filter a top boundary of the LCU.

19. The device of claim 15, wherein to determine the size for the current unit, the one or more processors are configured to:
determine that the current unit is positioned in a first row of LCUs; and
responsive to determining the current unit comprises a last LCU in the first row of LCUs, set the current unit size according to the formula (min (W+T, (PicW % W)+T)))*(W−T), wherein T is a number of lines required to filter the LCU, and W is a width of the LCU, and PicW is a width of the picture.

20. The device of claim 15, wherein to determine the size for the current unit, the one or more processors are configured to:
determine that the current unit is positioned in a first row of LCUs; and
responsive to determining the current unit comprises neither the first LCU nor the last LCU in the first row of LCUs, set the current unit size according to the formula W*(W−T), wherein T is a number of lines required to filter the LCU, and W is a width of the LCU.

21. The device of claim 15, wherein to determine the size for the current unit, the one or more processors are configured to:
determine that the current unit is positioned in a last row of LCUs; and
responsive to determining that the current unit is a first LCU in the last row of LCUs, set the current unit size according to the formula (LcuW−VT)*(LcuH−HT), wherein LcuW is a width of the LCU, VT is a number of right columns needed to filter a left boundary of the LCU, LcuH is a height of the LCU, and HT is a number of above rows needed to filter a top boundary of the LCU.

22. The device of claim 15, wherein to determine the size for the current unit, the one or more processors are configured to:
determine that the current unit is positioned in a last row of LCUs; and
responsive to determining the current unit comprises a last LCU in the last row of LCUs, set the current unit size according to the formula W*(min (W+T, (PicH % W)+T))), wherein PicH is a height of the picture, wherein T is a number of lines required to filter the LCU, and W is a width of the LCU.

23. The device of claim 15, wherein to determine the size for the current unit, the one or more processors are configured to:
determine that the current unit is positioned in a last row of LCUs; and
responsive to determining the current unit comprises neither the first LCU nor the last LCU in the last row of LCUs, set the current unit size according to the formula (min (W+T, (PicW % W)+T)))*(min (W+T, (PicH % W)+T))), wherein PicH is a height of the picture, wherein T is a number of lines required to filter the LCU, and W is a width of the LCU, and PicW is a width of the picture, and PicH is a height of the picture.

24. The device of claim 15, wherein to determine the size for the current unit, the one or more processors are configured to:
determine that the current unit is positioned in a row of LCUs that is neither a first row of LCUs nor a last row of LCUs; and
responsive to determining that the current unit comprises a first LCU in the row of LCUs, set the current unit size according to the formula (W−T)*W, wherein T is a number of lines required to filter the LCU, and W is a width of the LCU.

25. The device of claim 15, wherein to determine the size for the current unit, the one or more processors are configured to:
determine that the current unit is positioned in a row of LCUs that is neither a first row of LCUs nor a last row of LCUs; and
responsive to determining the current unit comprises a last LCU in the row of LCUs, set the current unit size according to the formula W*W, wherein W is a width and a height of the LCU.

26. The device of claim 15, wherein to determine the size for the current unit, the one or more processors are configured to:
determine that the current unit is positioned in a row of LCUs that is neither a first row of LCUs nor a last row of LCUs; and
responsive to determining the current unit comprises neither the first LCU nor the last LCU in the row of LCUs, set the current unit size according to the formula (min (W+T, (PicW % W)+T)))*W, wherein T is a number of lines required to filter the LCU, and W is a width of the LCU, and PicW is a width of the picture.

27. The device of claim 15, wherein, the one or more processors are configured to:
receive a syntax element that indicates whether or not a unit-based filtering technique is applied to a current unit of the video data.

28. The device of claim 15, wherein the LCU comprises a coding tree unit.

29. An apparatus for coding video data, the apparatus comprising:
means for determining filter information for a region of a picture of video data;
means for determining a size for a current unit based on a location of a largest coding unit (LCU) of the region within the picture, wherein the size for the current unit is different than a size of the LCU;
means for determining a filter for the current unit of the region based on the determined filter information; and
means for filtering the current unit with the determined filter.

30. A computer readable storage medium storing instructions that when executed cause one or more processors to:
determine filter information for a region of a picture of the video data;
for a largest coding unit (LCU) of the region, determine a size for a current unit based on a location of the LCU within the picture, wherein the size for the current unit is different than a size of the LCU;
based on the determined filter information, determine a filter for the current unit of the region; and
filter the current unit with the determined filter.
